(19) United States
(12) Patent Application Publication
(10) Pub. No.: US 2010/0083270 A1
(43) Pub. Date: Apr. 1, 2010

(54) RESOURCE CLASS BINDING FOR INDUSTRIAL AUTOMATION

(75) Inventors: Robert Kline, Phoenix, AR (US); Clark L. Case, Aurora, OH (US)

Correspondence Address: ROCKWELL AUTOMATION;for Turocy & Watson LLP, 1201 SOUTH SECOND STREET, E-7F19, MILWAUKEE, WI, 53204, US

(73) Assignee: ROCKWELL AUTOMATION TECHNOLOGIES, INC., Mayfield Heights, OH (US)

(21) Appl. No.: 12/241,215

(22) Filed: Sep. 30, 2008

(51) Int. Cl. G06F 9/44

(52) U.S. Cl. 718/104

(57) ABSTRACT

An industrial control system is provided. The system includes a processing component to bind to a subset of resources from a set of potential industrial control resources. An attribute component defines a resource priority for the set of potential industrial control resources. A resource class component implements at least one instance of the potential industrial control resources, where the instance automatically selects the subset of resources in view of the resource priority.

### TECHNICAL FIELD

The claimed subject matter relates generally to industrial control systems and more particularly to resource class structures that dynamically select automation resources from prioritizing attributes and determinations.

### BACKGROUND

Industrial controllers are special-purpose computers utilized for controlling industrial processes, manufacturing equipment, and other factory automation, such as data collection or networked systems. Controllers often work in concert with other computer systems to form an environment whereby a majority of modern and automated manufacturing operations occur. These operations involve front-end processing of materials such as steel production to more intricate manufacturing processes such as automobile production that involves assembly of previously processed materials. Often such as in the case of automobiles, complex assemblies can be manufactured with high technology robotics assisting the industrial control process.

In many automated processes, including the basic production of commodities such as food, beverages, and pharmaceuticals, complex state logic is often designed and programmed by Systems Engineers or provided in some cases by automated equipment manufacturers. This logic is often programmed with common PLC ladder logic or higher level languages supported by Sequential Function Charts. Sequence logic can be employed for a plurality of tasks such as material movement and conveying operations, packaging operations, or as part of an assembly process itself, wherein various stages of an assembly are sequenced from stage to stage until a final assembly occurs. As can be appreciated, much planning and design is required to implement an automated production process that can involve hundreds of machines, computers, and program logic to facilitate proper operation of the respective sequences.

One challenge facing industrial processing systems is related to how equipment is selected from a control program operated on a server. If a dozen pieces of equipment or resources were available to operate on a given unit, a separate portion of phase code would have to be written with the attendant logic to account for the nuance of each portion. This would require maintenance and validation of each portion of code and would require new phase logic to be added each time new equipment became available. Unfortunately, every time new logic is added to the system, a new validation would be required which adds considerable expense to software deployment and future maintenance of the software.

### SUMMARY OF THE INVENTION

The following summary presents a simplified overview to provide a basic understanding of certain aspects described herein. This summary is not an extensive overview nor is it intended to identify critical elements or delineate the scope of the aspects described herein. The sole purpose of this summary is to present some features in a simplified form as a prelude to a more detailed description presented later.

A programming framework is provided that enables resources to be programmatically selected while mitigating the requirements of writing explicit phase code per resource to perform the selection. Various binding attributes are analyzed by a processor to determine a potential candidate of equipment resources to bind to at runtime of a process. The candidate may be selected and bound based on a prioritization scheme, efficiency policy, or economic policy that would weight the selection of one piece of equipment over another. For example, a material exit valve may be chosen over another because a shorter pipeline to a final material destination is detected. In general, binding decisions are abstracted to a resource class, where the abstraction allows generalized code to control resource instances that are selected from the respective attributes. By generalizing the binding decisions in this manner to a class, a separate piece of phase code does not have to be added each time a new piece of equipment becomes available. This mitigates the deployment, validation, and maintenance of industrial automation code.

In general, resource allocation relates to determining a set of resources that are available, where binding is the process of actually selecting one particular resource from the set of potential candidates. Binding typically precedes arbitration that determines from the set of candidates which is best qualified. In one example, a class of resources such as a set of pumps to be used is specified. In prior art, an equipment phase was associated with each pump. Resource class binding allows one equipment phase (or a subset) to work with multiple pumps thus saving the programmer from having to write an equipment phase for each resource. Resource class binding thus provides an additional level of programmatic indirection by abstracting binding to a class. This type of binding runs at a level below unit attribute binding which can be employed in conjunction with resource class binding. For example, when a batch needs a pump and three are available for the unit being selected, given a resource class and a set of prioritizing attributes, a pump could be automatically selected from a group of available candidates.

To the accomplishment of the foregoing and related ends, the following description and annexed drawings set forth in detail certain illustrative aspects. These aspects are indicative of but a few of the various ways in which the principles described herein may be employed. Other advantages and novel features may become apparent from the following detailed description when considered in conjunction with the drawings.

### BRIEF DESCRIPTION OF THE DRAWINGS

FIG. 1 is a schematic block diagram illustrating resource class components that select industrial control resources based upon attributes or rules that classify or prioritize the resources.

FIG. 2 is a diagram illustrating example binding attributes for selecting industrial control resources.

FIG. 3 is a diagram illustrating example user interface for binding attributes.

FIG. 4 is a diagram illustrating example resource modules.

FIG. 5 is a flow diagram illustrating a method for selecting resources from an instance of a resource class.

FIG. 6 is a schematic block diagram illustrates an attribute processing and binding system.

FIG. 7 illustrates equipment editor enhancements.

FIG. 8 illustrates recipe editor enhancements.

FIG. 9 illustrates batch server enhancements.

FIG. 10 illustrates an exemplary data structure for attribute processing.

### DETAILED DESCRIPTION OF THE INVENTION

An industrial control system is provided that automatically adapts instances of a resource class to select equipment or other resources that have been classified via binding attributes. In one aspect, an industrial control system is provided. The system includes a processing component to bind to a subset of resources from a set of potential industrial control resources. An attribute component defines a resource priority for the set of potential industrial control resources. A resource class component implements at least one instance of the potential industrial control resources, where the instance automatically selects the subset of resources in view of the resource priority.

It is noted that as used in this application, terms such as “component,” “module,” “attribute,” “resource,” and the like are intended to refer to a computer-related entity, either hardware, a combination of hardware and software, software, or software in execution as applied to an automation system for industrial control. For example, a component may be, but is not limited to being, a process running on a processor, a processor, an object, an executable, a thread of execution, a program and a computer. By way of illustration, both an application running on a server and the server can be components. One or more components may reside within a process or thread of execution and a component may be localized on one computer or distributed between two or more computers, industrial controllers, or modules communicating therewith.

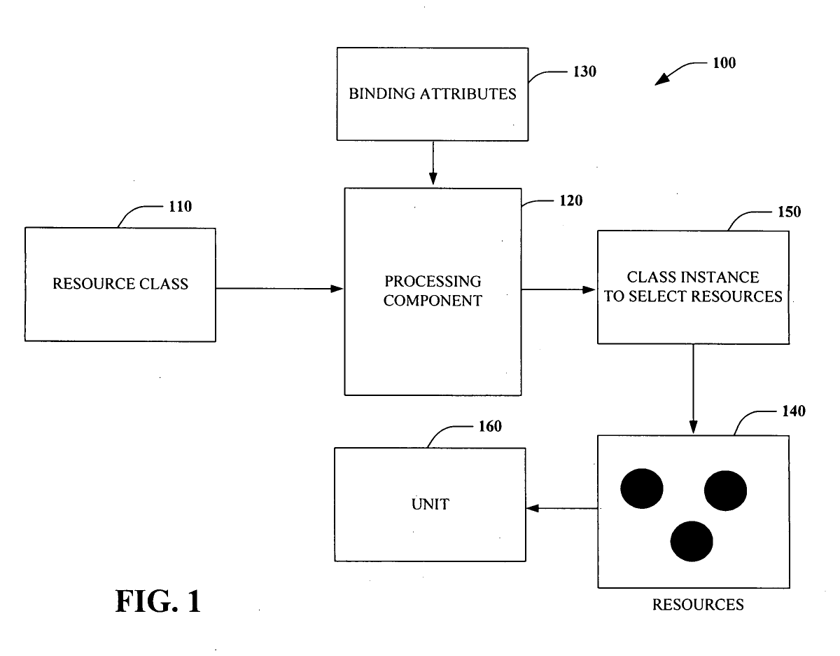

Referring initially to FIG. 1, a system 100 illustrates resource class components that select industrial control resources based upon attributes or rules that classify or prioritize the respective resources. A resource class component 110 is operated on by a processing component 120. The processing component 120 is typically a server or computer system such as a batch server for industrial control systems. The resource class component 110 (or components) specifies components of a recipe that are subsequently executed by the processing component 120, where the recipe identifies what aspects of a process are employed to produce a given recipe. In one example, an S88 standard provides models that define equipment control, procedure control, and activity. One aspect to implementing this and other standards is creating the ability to separate recipe development from equipment control through the use of an equipment module (not shown) that includes both actual equipment (e.g., tanks, pumps, etc.) and a software representation of the same hardware that includes all the process capabilities. For a given grouping of equipment, each process task is typically designated as a phase against that equipment module.

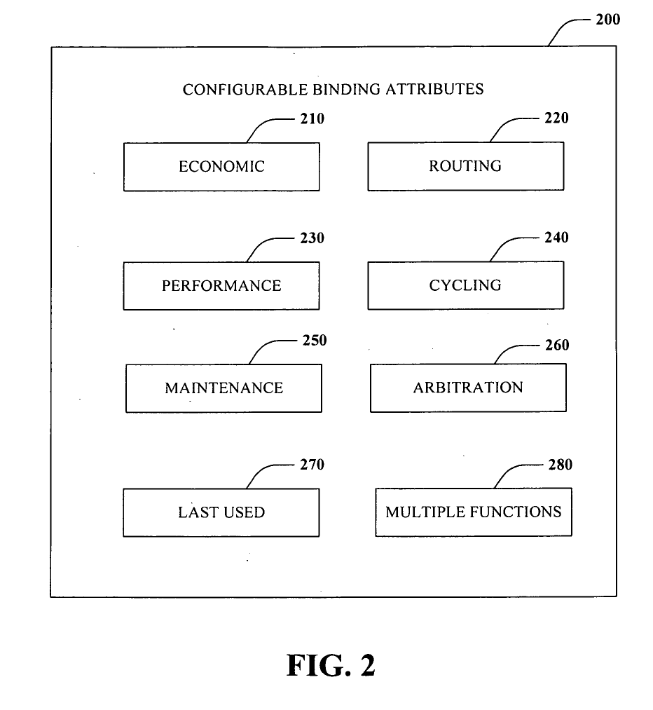

As shown, one or more binding attributes 130 are monitored by the processing component 120 to determine a classification or priority for industrial control resources 140. Such classification can include aspects like which piece of equipment or other resource should be employed from a set of resources, where the selected piece can be bound to a process based on various criteria specified by the attributes 130 and will be described in more detail below with respect to FIG. 2. Upon processing the attributes 130 which can be manually entered via a user interface or automatically detected, the processing component 120 generates a class instance 150 that is employed to automatically select one or more of the resources 140 from a set of potential resources (e.g., select a valve from a group of potential valves, select a pump from a group of potential pumps). In general, the processing component 120 binds to a subset of resources from a set of potential industrial control resources 140. The binding attributes 130 define a resource priority (or other classification) for the set of potential industrial control resources 140. The resource class 110 implements at least one instance 150 associated with the potential industrial control resources 140, where the instance automatically selects the subset of resources 140 in view of the priority or classification defined by the attributes. As shown, the resources 140 may be employed to work with a unit 160 such as a container or vessel for example. In one example, an exit valve may be selected from a group of exit valves 140, where the valve is determined to be the best candidate to remove material from the unit 160. Such decision is based on the binding attributes 130 such that the valve selected meets some criteria (e.g., fastest or shortest piping route for material exit from the vessel, selected for normal rotation of valves, selected for highest performance, and so forth).

In one aspect, the system 100 enables resources 140 to be programmatically selected while mitigating the requirements of writing explicit phase code per resource to perform the selection. Various binding attributes 130 are analyzed by the processing component 120 to determine a potential candidate of equipment resources 140 to bind to at runtime of a process. The candidate may be selected and bound based on a prioritization scheme, efficiency policy, or economic policy that would weight the selection of one piece of equipment over another. For example, a material exit valve may be chosen over another because a shorter pipeline to a final material destination is detected. In general, binding decisions are abstracted to the resource class 110, where the abstraction allows generalized code to control resource instances 150 that are selected from the attributes 130. By generalizing the binding decisions in this manner to a resource class 110, a separate piece of phase code does not have to be added each time a new piece of equipment becomes available. This mitigates the deployment, validation, and maintenance of industrial automation code.

In general, resource allocation relates to determining a set of resources 140 that are available, where binding is the process of actually selecting one particular resource from the set of potential candidates. Binding typically precedes arbitration that determines from the set of candidates which is best qualified. In one example, a class of resources 140 such as a set of pumps to be used is specified. In prior art, an equipment phase was associated with each pump. Resource class binding allows one equipment phase (or a subset of phases) to work with multiple pumps thus saving the programmer from having to write an equipment phase for each resource. Resource class binding thus provides an additional level of programmatic indirection by abstracting binding to a class. This type of binding runs at a level below unit attribute binding which can be employed in conjunction with resource class binding and is described in more detail below. For example, when a batch needs a pump and three are available for the unit being selected, given a resource class 110 and a set of prioritizing attributes 130, a pump (or other resource) can be automatically selected from a group of available candidates.

It is noted that components associated with the system 100 can include various computer or network components such as servers, clients, controllers, industrial controllers, programmable logic controllers (PLCs), batch controllers or servers, distributed control systems (DCS), communications modules, mobile computers, wireless components, control components and so forth that are capable of interacting across a network. Similarly, the term controller or PLC as used herein can include functionality that can be shared across multiple components, systems, or networks. For example, one or more controllers can communicate and cooperate with various network devices across the network. This can include substantially any type of control, communications module, computer, I/O device, sensors, Human Machine Interface (HMI) that communicate via the network that includes control, automation, or public networks. The controller can also communicate to and control various other devices such as Input/Output modules including Analog, Digital, Programmed/Intelligent I/O modules, other programmable controllers, communications modules, sensors, output devices, and the like.

The network can include public networks such as the Internet, Intranets, and automation networks such as Control and Information Protocol (CIP) networks including DeviceNet and ControlNet. Other networks include Ethernet, DH/DH+, Remote I/O, Fieldbus, Modbus, Profibus, wireless networks, serial protocols, and so forth. In addition, the network devices can include various possibilities (hardware or software components). These include components such as switches with virtual local area network (VLAN) capability, LANs, WANs, proxies, gateways, routers, firewalls, virtual private network (VPN) devices, servers, clients, computers, configuration tools, monitoring tools, or other devices.

Turning now to FIG. 2, examples of configurable binding attributes 200 are provided for selecting industrial control resources. It is noted that the attributes described herein are configurable by another system, a user, or a combination thereof. In one aspect, economic attributes 210 may be considered. These aspects define or characterize an economic quality about a given resource such as the cost to operate the resource or the amount of waste that may be generated when utilizing the resource. For example, if three pumps were available, and one operated at a higher efficiency and identified via a parameter associated with the pump, if the attribute 200 specified use the highest efficiency pump, then the pump available with the highest efficiency rating could be selected. At 220, routing attributes may be considered. Routing attributes 220 define characteristics about the inlet and outlet travels to a container or unit. For example, the distance traveled to receive or transport a material or specified by the time it might take to receive or transport a given material which implies which valve from a set of potential candidates is employed to input or output materials from the vessel. At 230, performance attributes processed. These can be substantially any type of attribute for specifying performance of a resource or the overall capabilities of the resource. For example, a set of motors operating pumps may be specified in horsepower or RPM's where the particular attribute specifies some aspect of the performance (e.g., select the motor with the highest RPM, select the motor that utilizes the most or the least amount of power, and so forth).

Proceeding to 240, cycling attributes may be specified. Such attributes may be rotating parameters that float between resources to allow cycling of operation between the set. Thus, instead of always using the same pump, use a different pump on the next cycle in order to spread the load across a set of equipment. At 250, maintenance attributes can be considered. These attributes can be utilized to favor one subset of equipment over another to allow one or more resources to be properly maintained. This can include prioritizing a certain amount of downtime so that equipment can be properly serviced. At 260, some attributes can be assigned by the resources or local control stations. For instance, resources that arbitrate amongst themselves to determine availability can assign an attribute indicating which resource has priority over another. Substantially any type of prioritizing code or tag can be employed to indicate that one piece of equipment has a priority for selection that is greater than another piece. At 270, a last used attribute can be specified. This type of attribute may indicate some quality about an inlet or exit feed for instance that may make prioritize it for subsequent operations. For instance, if a pipe exit feed is coated with some material from a previous drain operation, the coating on that respective pipe may not be suitable for a subsequent fill operation to another vessel unless the pipe itself is first cleaned. At 280, multiple function considerations can be defined as attributes. For example, one pump may be able to both draw a new material from one source while generating a voltage for another portion of a process. One type of attribute may specify a higher priority to multi-function equipment as opposed to resources having less functionality. As can be appreciated, substantially any type of tag or qualifier that can be assigned to a resource can be employed as an attribute 200 to distinguish a subset of resources among a set of resources.

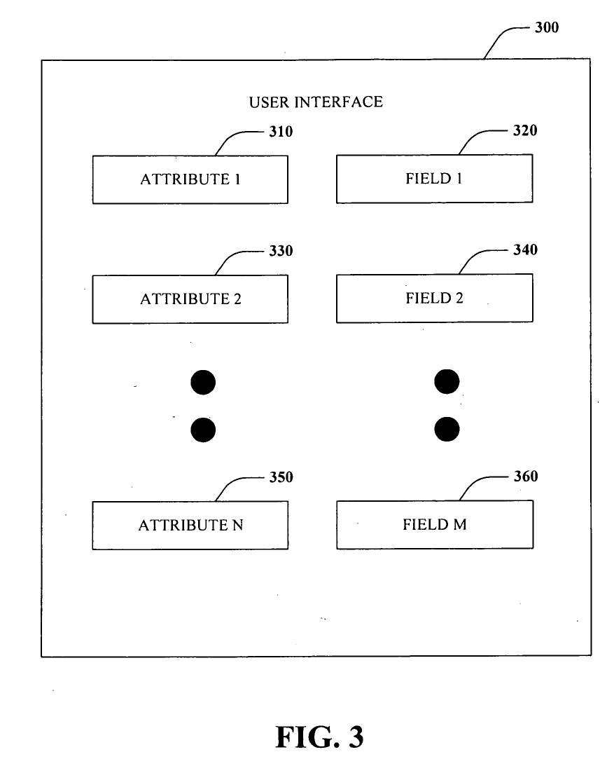

Referring now to FIG. 3, a user interface 300 is provided so a user can communicate data to define resource classes and attributes described above. In one aspect, the user can specify a multitude of attributes that correspond to user desires or design goals. For example, the user could provide a plurality of goals or operating conditions in the specification that include operating temperature, and a desired quantity of product to be produced per time frame. An attribute box 310 is provided to permit the user to label individual attributes from different portions of a specification or other type input, for example. A field box 320 is provided in the user interface 300 to enable the user to input a particular specification that corresponds to the label in parameter box 310.

Alternatively, the user interface 300 can automatically fill the parameter box labels for the user if existing attributes are commonly used. The user interface 300 can communicate with a database component (not shown) to determine possible attributes, attribute ranges, and attribute limits. Upon retrieval of the attribute data, the user interface 300 can present this information to the user in the form of a attribute box label 310 and a field drop down selection box 320. For instance, a programmable controller controlling a motor may be expected to have different operating speed settings or revolutions per minute (RPM) settings. The user interface 300 can communicate with a database component (not shown) and determine the variables that could be included as attributes such as input voltage, operating speed (RPMs), and torque. The user interface 300 may determine that the motor could accept three input voltage levels: low, nominal, and high, for example. The user interface 300 may further determine that the motor outputs run at either a low or high level of torque and that it can run between five hundred and one thousand RPMs. Upon determination of the attribute data, the user interface 300 automatically labels parameter box 310 with an “Input Voltage” label and creates a drop down box in field box 320 that lists the three possible settings for the user to choose. Similarly, the user interface 300 can label parameter box 330 as “Torque” and create a drop down box with the two possible settings from which the user could choose. Again, the user interface 300 can automatically label parameter box 350 as “RPM setting”. In this situation, however, field box 360 may be left blank and the user interface 300 could prompt the user to input an RPM number between five hundred and one thousand.

It is to be noted that the claimed subject matter is not limited to attributes that are stored within a database. The user may input attributes that do not directly correspond to a particular component. For instance, a user could provide an attribute that recites output of one hundred units per day. The user interface 300 may facilitate the implementation of such an attribute through the determination of suitable process control equipment or processes. Based upon specifications of the user, and those capabilities detected from the equipment or other resources (e.g., memory, processing speed), the class instances described above can be utilized by the processing component to select such resources. For example, if higher throughput is specified than can be handled by one piece of equipment, it is possible to initialize other equipment to increase capacity or capability of an overall process. In another aspect, an industrial control system for batch processing is provided. The system includes means for defining one or more resource classes (user interface 300) for a batch process and means for generating class instances (processing component 120 of FIG. 1) from the resource classes in view of one or more detected binding attributes. The system also includes means for selecting equipment (class instances 150 of FIG. 1) in the batch process in view of the binding attributes.

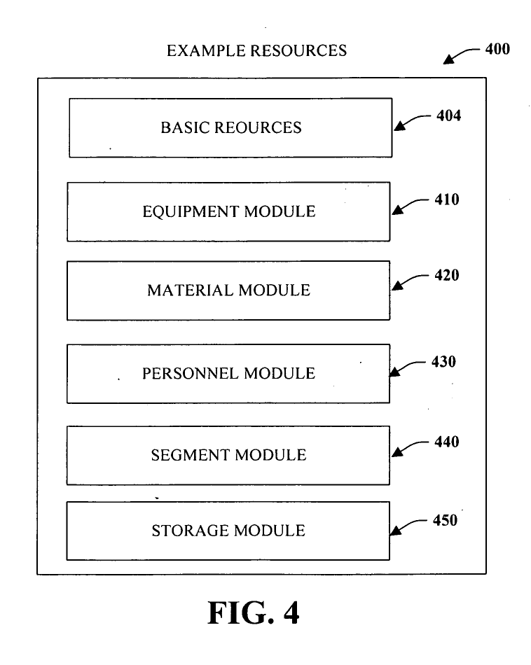

FIG. 4 illustrates example resource modules 400 for an industrial control system. At 404, basic resources are considered. These are sometimes referred to in S88 terminology as control modules and include resources such as pumps, valves, mixers, heaters, chillers, and so forth. At 410, an Equipment Module provides coordination of equipment modules and equipment control modules to perform a process orientated task independent of specific material e.g., In-feed, AGV controller, Conveyor, and so forth. At 420, a Material Module provides coordination of material modules and material control modules to perform material focused tasks e.g., Material reservation, provision, material mass balance calculation, Bill of Material management, Work order management, and so forth. At 430, a Personnel Module provides coordination of personnel modules and personnel control modules to perform personnel focused tasks e.g., Electronic signature collection, Security validation, certification validation, Manual control interactions, and so forth.

At 440, a Segment Module provides coordination of segment modules and segment control modules and to execute sequences of tasks represented by segments. Segments define resource requirements and ordering that can represent most production and process activities. This module provides access to more complex tasks that require specific sequences to be followed e.g., Process Analytics Technology (PAT) integration, electronic signatures collection, defect, process deviation and fault recovery processing. The segment module 440 may also construct a sequence to be followed which can be applied as manual, automatic or semi-automatic sequences (e.g., Route, recipe execution). At 450, a Storage Module provides coordination of storage related activities, allocation of storage to requesters, modeling of inventory calculations and so forth. This also includes interaction with higher-level systems that manage storage and inventory information.

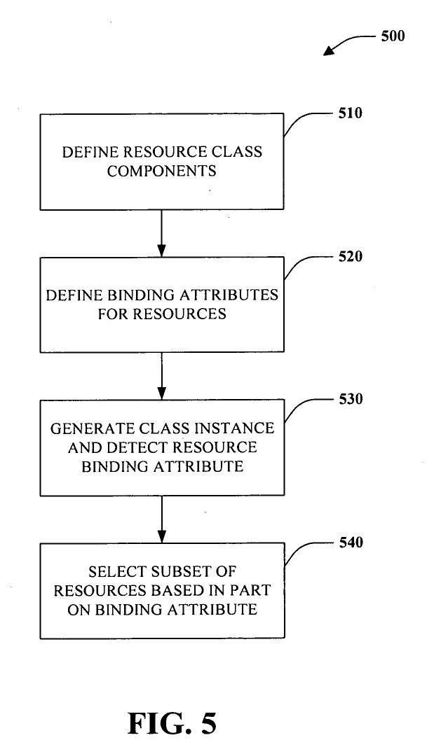

FIG. 5 is a flow diagram illustrating a method 600 for selecting resources from class instances of a resource class. While, for purposes of simplicity of explanation, the methodology is shown and described as a series of acts, it is to be understood and appreciated that the methodologies are not limited by the order of acts, as some acts may occur in different orders or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as described herein.

Proceeding to 510, a resource class is defined. The resource class specifies the type of resources or equipment that is employed to execute a recipe. At 520, one or more binding attributes are processed to determine those qualities that prioritize or characterize one type of equipment from another within a common class. For instance, prioritizing a set of pumps that are defined from a class of pumps. As noted previously, such attributes can include economic attributes, routing attributes, performance attributes, cycling attributes, maintenance attributes, arbitration attributes, last used attributes, multiple function attributes, or other attributes for prioritizing or categorizing members of the resource class. Upon processing the attributes at 520 which can be manually entered via a user interface or automatically detected as previously noted, a class instance is generated at 530 and detects binding attributes associated with members of a resource or equipment class. For example, if a set of five valves were available to drain a holding tank, each valve may report its respective attribute relating to the routing capabilities of the valve. If the preference for a particular recipe was to route to the shortest distance from the tank, then the valve associated with a distance attribute indicating the shortest length from the tank would be selected. At 540, the resource most closely associated with the attribute of preference is automatically selected from a grouping of similar resources.

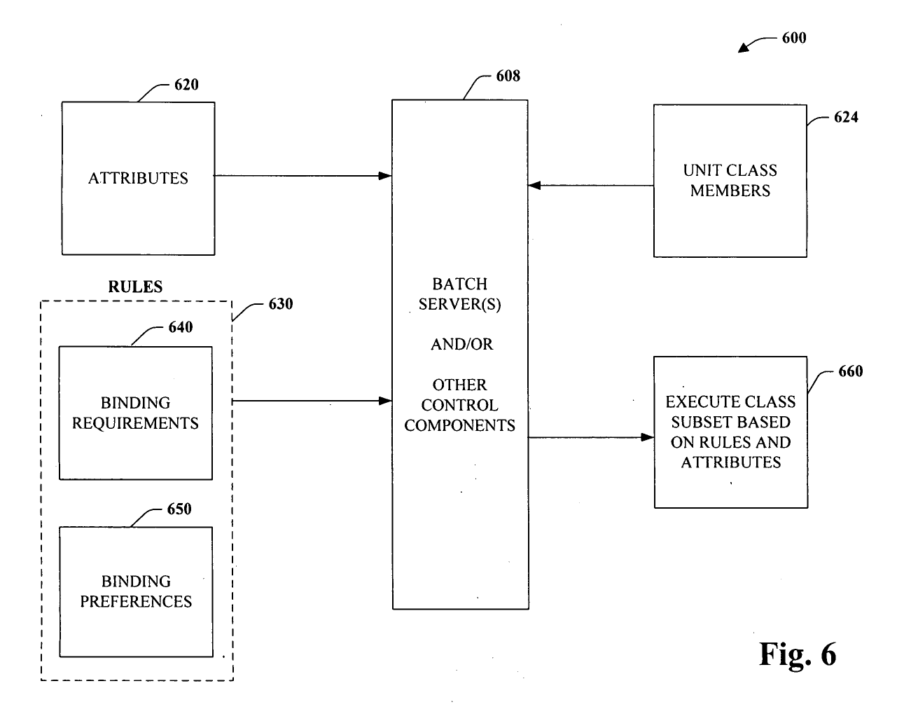

Referring to FIG. 6, a system 600 illustrates attribute processing and binding. The system 600 includes a controller 608 (or controllers, processors, servers and so forth) that processes one or more attributes 620 that can be specified as part of a recipe, batch or program. The attributes 620 describe a subset of functionality that applies to members of a class at 624 (e.g., equipment employed for a batch operation modeled as an object class). For instance, these attributes 620 may refer to a parameter such as pressure or temperature that can then be employed by the controller 608 to select available equipment or components that are members of the class 624. In one example, recipe chemistry can be declared as an attribute 620, whereby one or more rules 630 can be declared that control how the attribute is applied. Proceeding with this example, the rule 630 could specify to use glass-lined containers only from a larger set of containers in view of the required chemistry for the associated process.

In another example, the rule 630 could select a warmest reactor from an available set of reactors when performing a batch operation. These rules 630 can be provided as binding requirements 640 (e.g., Boolean expressions), wherein such rules are entered as part of an equipment or recipe editor for example. Another component includes binding preferences 650 to resolve conflicts between the binding requirements 640—if they exist. For instance, if the rule 630 were to select the warmest reactor, and two reactors were measured the warmest and having the same temperature, the binding preference 650 can be employed (e.g., select the warmest reactor that is furthest away from a maintenance event). The attributes 620 and rules 630 are employed by the controller 608 to resolve which members or subset of the class 624 are to be executed at 660. Also, the controller 608 can include one or more batch servers and/or other control components (e.g., I/O modules, communications modules) coupled via a network connection to affect operations within the controller 608. Such control components can include controllers, computers, batch servers or processors, other modules, and so forth. It is to be appreciated that the concept of “Attributes”, and “Rules” involving “Binding Requirements” and “Binding Preferences” can be employed for the purpose of selection of any type of object in addition to example objects such as “Units” and “Equipment Modules” described herein.

As will be described in more detail below, several components such as tag classes, equipment editors, recipe editors, and batch processor or server components can be modified to provide the attribute-based binding and equipment selection in accordance with the subject invention. The equipment editor generally interacts with an area model that defines an equipment association between a container that holds inventory and an equipment module that has a physical association with the container, whereas the recipe editor can be employed for manipulating recipes that describe the necessary components of a manufacturing process. The batch server can be a networked computer that executes the recipe while interacting with control systems to produce various commodities associated with the recipe

In general, the above considerations can include providing a component to allow a user to build recipes that reference a subset of functionality that exists within the members of the Unit Class 624 (or resource class), providing a component to allow users to restrict the set of members of the Unit class on which a class based recipe can run, based on “attributes” 620 of the Units, and providing a component to allow the user to specify an algorithm for determining the most “preferred” unit to be used by a recipe when more than one member of a Unit Class satisfies the restriction requirements.

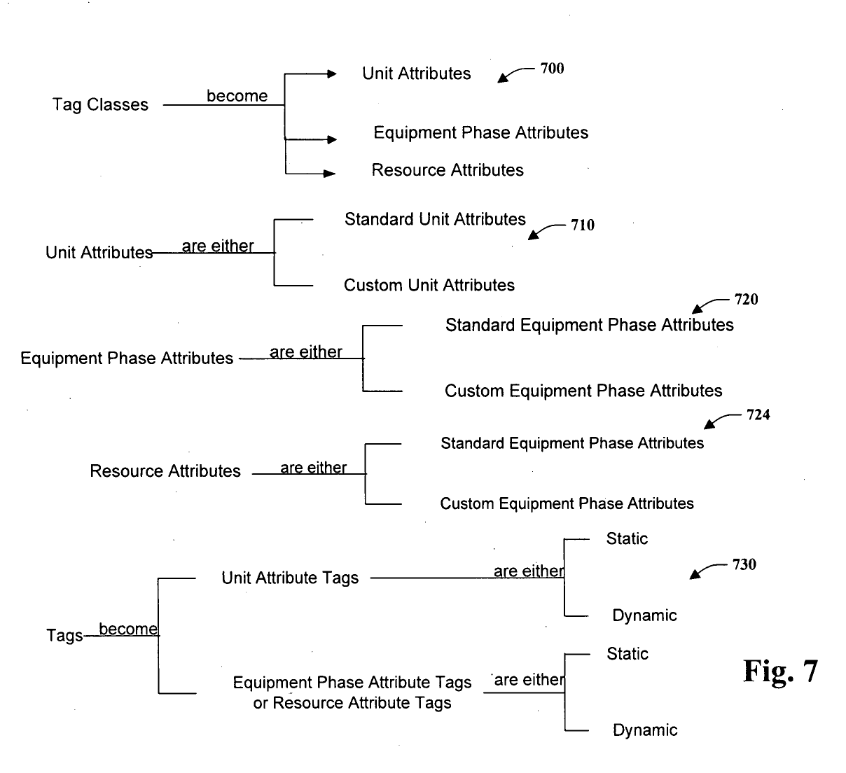

FIGS. 7-9 illustrate equipment editor, recipe editor, and batch server enhancements for providing attribute binding in accordance with the subject invention. Referring now to FIG. 7, equipment editor enhancements are illustrated in accordance with an aspect of the subject invention. At 700, Tag Classes can be defined as Attributes, and separated into Unit Attributes, Equipment Phase Attributes, and Resource Attributes. At 710 Unit Attributes can be organized into Standard and Custom Attributes. Standard Attributes are those attributes used by functions within the product software. Custom Attributes are defined by customers for their own use. Examples of Standard Unit Attributes include CAPACITY, and so forth. Examples of Custom Unit Attributes include MATERIALS OF CONSTRUCTION, CIP STATUS, LEVEL, and so forth.

At 720, Equipment Phase Attributes can be separated into Standard and Custom Attributes. Standard Attributes are used by functions within product software, while Custom Attributes will be those defined by customers for their own use. Similarly, Resource attributes can be separated into Standard and Custom Attributes at 724. At 730 Tags can be defined as Attribute Tags, and separated into Unit Attribute Tags, Equipment Phase Attribute Tags, or Resource Attribute Tags. When defining an Attribute Tag, users can configure the tag as being a Dynamic Tag (an external data source) or a Static Tag (a constant value).

Static Attribute Tags are used to represent unchanging characteristics of equipment. MATERIALS OF CONSTRUCTION is an example of a Unit Attribute that would typically be represented with a Static Unit Attribute Tag. Dynamic Attribute Tags are used to represent changing characteristics of equipment. TEMPERATURE is an example of a Unit Attribute that would typically be represented with a Dynamic Unit Attribute Tag.

The Equipment Editor can also be enhanced to permit building of Global Binding Requirements. Global Binding Requirements can be constrained to be of a Boolean Expression type. A Boolean Expression that represents a Global Binding Requirement is capable of referencing Global Unit Attributes. Boolean Expression objects will also be capable of referencing key values located in the recipe header data, such as BATCH_SIZE. At runtime, Units for which the Boolean Expression evaluates to FALSE are not considered legal bind targets.

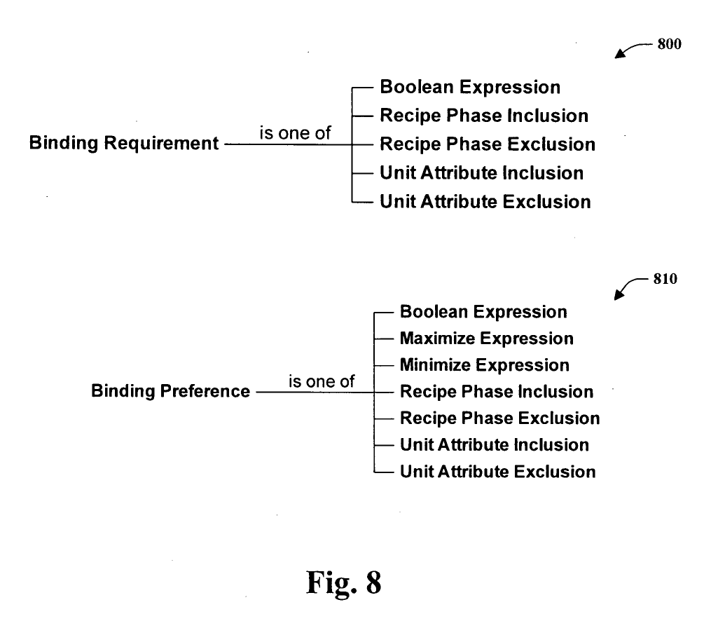

FIG. 8 illustrates recipe editor enhancements in accordance with an aspect of the subject invention. A recipe editor (not shown) can be enhanced to permit the building of Binding Requirements associated with class based Unit Requirements. A Binding Requirement can be one of five types of objects at 800. A Boolean Expression that represents a Binding Requirement is capable of referencing Unit Attributes assigned to the Unit Class associated with the Unit Requirement. Boolean Expression objects are also capable of referencing key values located in recipe header data, such as BATCH_SIZE. At runtime, Units for which the Boolean Expression evaluates to FALSE are not considered legal bind targets.

A Recipe Phase Inclusion Binding Requirement mandates that the Unit Requirement is bound to a Unit that provides support for a specified Recipe Phase. When this type of Binding Requirement is created, the recipe author is now able to use the specified Recipe Phase in recipes built against Unit Requirement. A Recipe Phase Exclusion Binding Requirement mandates that the Unit Requirement is bound to a Unit that does not support a specified Recipe Phase. This type of Binding Requirement is primarily used to prevent a recipe from using Units with unneeded capabilities.

A Unit Attribute Inclusion Requirement mandates that the Unit Requirement is bound to a Unit that supports a specified Unit Attribute. When this type of Binding Requirement is created, the recipe author is now able to reference the specified Unit Attribute from transitions inside of Unit Operations and Unit Procedures associated with the Unit Requirement. A Unit Attribute Exclusion Binding Requirement mandates that the Unit Requirement is bound to a Unit that does not support a specified Unit Attribute. This type of binding requirement would primarily be used to prevent a recipe from using Units with unneeded instrumentation.

It is noted that when a lower level recipe procedure is inserted inside of a higher level recipe procedure, Binding Requirements may employ a “bubble-up” algorithm. For example, if a Unit Operation recipe has a Binding Requirement that requires a MATERIALS OF CONSTRUCTION value of STAINLESS STEEL, then this Binding Requirement should “bubble-up” to the Unit Procedure level if the Unit Operation is inserted into a Unit Procedure recipe. Some form of conflict resolution can be provided in the event that a Binding Requirement at a higher recipe level conflicts with a Binding Requirement in a lower level recipe being inserted into the higher level recipe's structure.

The recipe editor can also be enhanced to permit the Building of Binding Preferences associated with class based Unit Requirements. A Binding Preference can be one of seven types of objects as depicted at 810. A Boolean Expression that represents a Binding Preference is capable of referencing Unit Attributes assigned to the Unit Class associated with the Unit Requirement. Boolean Expression objects will also be capable of referencing key values located in recipe header data, such as BATCH_SIZE. At runtime, Units for which the Boolean Expression evaluates to TRUE are considered preferred binding candidates to those Units for which the Boolean Expression evaluates to FALSE.

A Maximize Expression that represents a Binding Preference is an expression that evaluates to an integer or real value. A Maximize Expression is capable of referencing Unit Attributes assigned to the Unit Class associated with the Unit Requirement. Maximize Expressions are also capable of referencing key values located in recipe header data, such as BATCH_SIZE. At runtime, Units for which the Maximize Expression evaluates to a higher value can be considered preferred binding candidates to those Units for which the Maximize Expression evaluates to a lower value.

A Minimize Expression that represents a Binding Preference is an expression that evaluates to an integer or real value. A Minimize Expression is capable of referencing Unit Attributes assigned to the Unit Class associated with the Unit Requirement. Minimize Expressions are also capable of referencing key values located in recipe header data, such as BATCH_SIZE. At runtime, Units for which the Minimize Expression evaluates to a lower value are considered preferred binding candidates to those Units for which the Minimize Expression evaluates to a higher value.

A Recipe Phase Inclusion Binding Preference specifies a Recipe Phase. Units that provide support for the specified Recipe Phase are considered preferred binding candidates to Units that do not. A Recipe Phase Exclusion Binding Preference specifies a Recipe Phase. Units that do not provide support for the specified Recipe Phase are considered preferred binding candidates to Units that do. This type of Binding Preference would primarily be used to cause a recipe to avoid running on Units with unneeded capabilities.

A Unit Attribute Inclusion Binding Preference specifies a Unit Attribute. Units that provide support for the specified Unit Attribute are considered preferred binding candidates to Units that do not. A Unit Attribute Exclusion Binding Preference specifies a Unit Attribute. Units that do not provide support for the specified Unit Attribute are considered preferred binding candidates to Units that do. This type of Binding Preference is primarily used to cause a recipe to avoid running on Units with unneeded instrumentation. Some form of conflict resolution can be provided in the event that a Binding Preference at a higher recipe level conflicts with a Binding Preference in a lower level recipe.

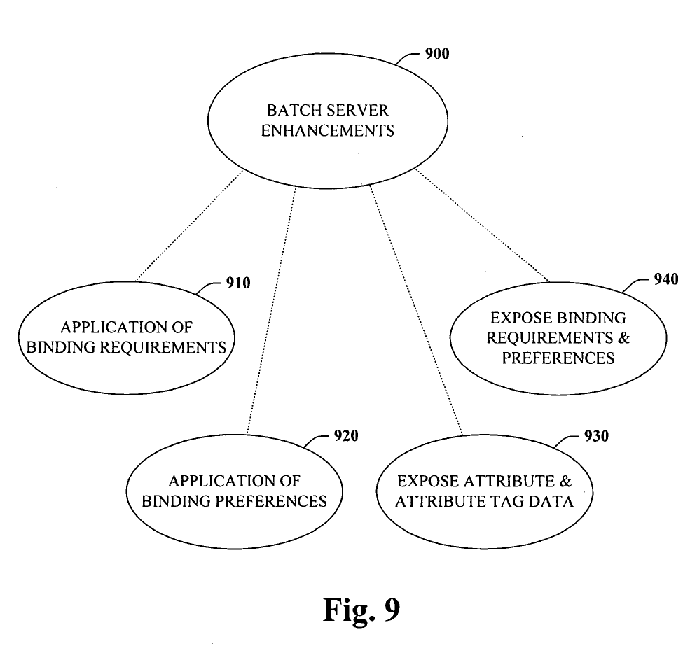

Referring now to FIG. 9, batch server enhancements 900 are illustrated in accordance with an aspect of the present invention. At 910, application of Binding Requirements are considered. When the Batch Server attempts to bind a Unit Requirement, it can first trim the list of legal bind target candidates using existing flow path algorithms. If at least one legal bind target remains after executing these algorithms, then the Binding Requirements will be evaluated against all remaining bind targets. Any bind target that does not meet ALL of the Binding Requirements will be removed from the list of legal bind targets. If no legal bind targets remain after trimming the legal bind targets, then appropriate error handling measures will be taken.

At 920, Application of Binding Preferences are considered. If more than one binding candidate remains after trimming the set of legal candidates, then the remaining set can be sorted into a “preferred” order. Binding Preferences can be used for this purpose. Whichever Binding Preference is defined to be the primary sort will be used as such, the secondary sort used as such, and so on.

At 930, Exposing of Attribute and Attribute Tag Data is considered. The Batch Server can expose Attribute and Attribute Tag data to external clients through new data items. The following sets of data items can be created:
A single data item to expose the set of Custom Unit Attributes defined in an Area Model
A set of data items (1 per Unit Class) to expose the Unit Attributes assigned to a Unit Class
A set of data items (1 per Unit) to expose the Unit Attribute Tag values for a Unit
A single data item to expose the set of Equipment Phase Attributes defined in the Area Model
A set of data items (1 per Recipe Phase) to expose the Equipment Phase Attributes assigned to a Recipe Phase
A set of data items (1 per Equipment Phase) to expose the Equipment Phase Attribute Tag values for an Equipment Phase

At 940, Exposing of Binding Requirements and Binding Preferences are considered. The Batch Server can be enhanced to expose Binding Requirements and Binding Preferences on Unit Requirements contained within instantiated recipes. The following sets of data items can be employed as an example:
A data item per Batch Procedure to expose the set of Unit Requirements defined within
A data item per Unit Procedure to expose the Unit Requirement defined within
A data item per Unit Operation to expose the Unit Requirement defined within
A data item per Unit Requirement to expose its set of Binding Requirements
A data item per Unit Requirement to expose its ordered set of Binding Preferences

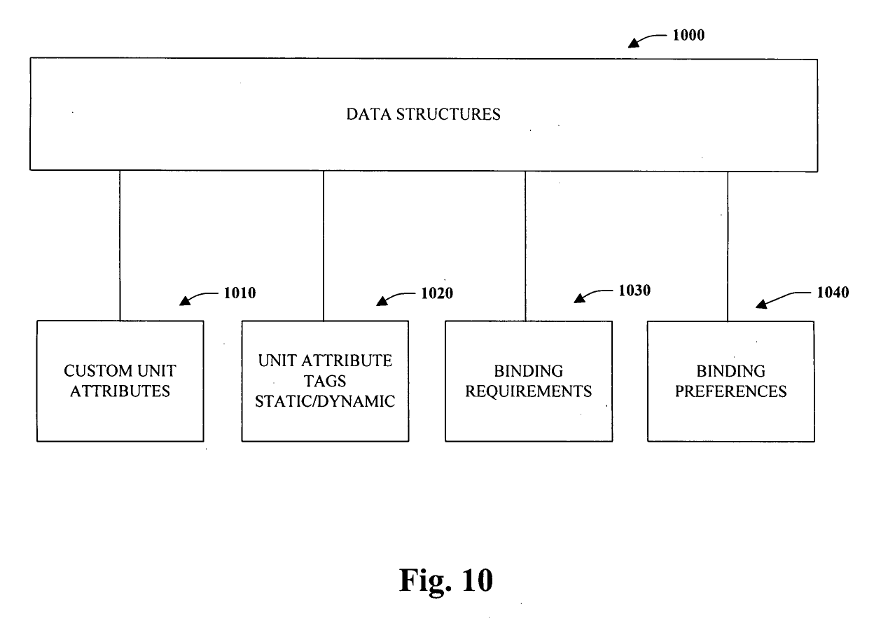

Turning to FIG. 10, an exemplary data structure 1000 is illustrated in accordance with an aspect of the present invention. At 1010, Custom Unit Attributes can be provided. Generally, the user defines Custom Unit Attributes in the Equipment Editor. When building Unit Classes, the user will select which Unit Attributes apply to the specific Unit Class. For each Unit Attribute, the following information may be configured:

| | |
|---|---|
| Attribute Name | This is a string is the name of the Attribute. Legal |
| | characters will follow the naming conventions |
| | used for other Area Model objects. |
| Type | The data type of the Attribute, either Enumeration, |
| | Real, Integer, or String. |
| Enumeration | This field is applicable when the Type is “Enumeration”. |
| Set | This contains the name of the Enumeration set that |
| | completes the Type definition of |
| | the Unit Attribute. |
| Engineering | The engineering units for Attribute Value Tags |
| Units | representing this Attribute. |
| Default | The default value to be used when a Unit's |
| | Attribute Value Tag representing this Attribute is |
| | configured to be a Static Unit Attribute Tag. |
| Description | A string that contains a description of the Attribute. |
| ID | A unique integer value that identifies the Attribute. |
| Global | A flag indicating if the Unit Attribute is to be considered |
| | a Global Unit Attribute. |

At 1020, Unit Attribute Tags are provided that include static and dynamic tags. When configuring a Unit, the Equipment Editor can created one Unit Attribute Tag for each Global Unit Attribute and one tag for each Unit Attribute associated with the Unit's Unit Class. Each Attribute Tag can be configured as being either a Dynamic or Static Tag. When configuring a Static Unit Attribute Tag, the static value can be initialized to the default specified in the Unit Attribute's Default value. The user can change the value of the Static Unit Attribute Tag within the Equipment Editor. The “static” nature of the Unit Attribute Tag refers to its unchanging value in the Batch Server. The data type of the Static Unit Attribute Tag is controlled by the Type and Enumeration Set fields of the Unit Attribute's configuration data. Dynamic Unit Attribute Tags allow the Batch Server to access an external data source for the runtime value of a specific Unit's Attribute.

At 1030, the Equipment Editor permits the Area Model author to build a list of Global Binding Requirements. These Global Binding Requirements are the Boolean Expression type and are applied to Unit Requirements within the recipes. The Recipe Editor will permit a recipe author to build a list of Binding Requirements on every Unit Requirement object, if desired. At 1040, the Recipe Editor permits a recipe author to build an ordered list of Binding Preferences on each Unit Requirement object, if desired.

The subject matter as described above includes various exemplary aspects. However, it should be appreciated that it is not possible to describe every conceivable component or methodology for purposes of describing these aspects. One of ordinary skill in the art may recognize that further combinations or permutations may be possible. Various methodologies or architectures may be employed to implement the subject invention, modifications, variations, or equivalents thereof. Accordingly, all such implementations of the aspects described herein are intended to embrace the scope and spirit of subject claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An industrial control system, comprising:
a processing component to bind to a subset of resources from a set of potential industrial control resources;
an attribute component to define a resource priority for the set of potential industrial control resources; and
a resource class component to implement at least one instance of the potential industrial control resources, the instance automatically selects the subset of resources in view of the resource priority.

2. The system of claim 1, the attribute component is configurable by a system or a user.

3. The system of claim 1, the attribute component is associated with a routing capability that defines path for a material to travel or an economic indicator that defines a monetary quality of a resource.

4. The system of claim 1, the attribute component is associated with a performance quality that defines an electrical or mechanical performance criteria of a resource.

5. The system of claim 1, the attribute component is associated with cycling parameter that defines how often a resource is to be utilized.

6. The system of claim 1, the attribute component is associated with a maintenance parameter that prioritizes resources based upon a maintenance cycle.

7. The system of claim 1, the attribute component is associated with an arbitration parameter for resources that have been previously prioritized.

8. The system of claim 1, the attribute component is associated with a last used parameter that defines a quality of material that was last used by a resource.

9. The system of claim 1, the attribute component is associated with a multiple function parameter that defines the number of functions available for a specified resource.

10. The system of claim 1, further comprising a user interface to define or modify the attribute component or the resource class component.

11. The system of claim 1, further comprising at least one unit that is operated on by the subset of resources.

12. The system of claim 1, further comprising at least one of an equipment module, a material module, a personnel module, a segment module, or a storage module.

13. The system of claim 1, further comprising at least one of a binding preferences component or a binding requirements component.

14. The system of claim 13, further comprising at least one of a tag class, a resource attribute, a unit attribute, or an equipment phase attribute.

15. The system of claim 13, the binding preferences component or the binding requirements component include expressions, inclusions, or exclusion parameters.

16. The system of claim 13, further comprising custom attributes, static attributes, or dynamic attributes.

17. A method of controlling resources in an industrial control process, comprising:
specifying resource classes for a batch process;
monitoring binding attributes associated with the batch process;
generating class instances in view of the binding attributes; and
selecting a subset of resources in the batch process via the class instances.

18. The method of claim 17, the binding attributes further comprising economic attributes, routing attributes, performance attributes, cycling attributes, maintenance attributes, arbitration attributes, last used attributes, or multiple function attributes.

19. The method of claim 17, further comprising defining one or more binding requirements or binding preferences in view of the binding attributes.

20. An industrial control system for batch processing, comprising:
means for defining one or more resource classes for a batch process;
means for generating class instances from the resource classes in view of one or more detected binding attributes; and
means for selecting equipment in the batch process in view of the binding attributes.
